(19) United States
(12) Patent Application Publication
(10) Pub. No.: US 2005/0204596 A1
(43) Pub. Date: Sep. 22, 2005

(54) Portable seat back display

(76) Inventor: Juen Tien Peng, Chung Li (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/802,793

(22) Filed: Mar. 18, 2004

(51) Int. Cl. G09F 3/00

(52) U.S. Cl. 40/320; 297/188.04

(57) ABSTRACT

A portable seat back display for a back of a chair includes a housing, a display module and a connecting mechanism. The housing includes a frame for with a receiving chamber. The frame includes a backboard and two side walls thereby defining a receiving space therebetween. The backboard has a receptacle. The display module is detachably assembled in the receiving space of the frame and has a complementary connector for connecting with the receptacle of the frame thereby providing the display module with power supply and display signals. The connecting mechanism removably connects the housing and the display module. The display module is rotatable in the receiving space of the housing.

### BACKGROUND OF THE INVENTION

1. Field of the Invention

The present invention relates to a display device, and mare particularly to a portable seat back display for a back of a chair or seat which may be used in a vehicle or other locations.

2. Prior Art

Due to developments in the modern economy and the prevalence of constructed roads, automobiles have become a major vehicle for transportation and commuting. Some buses are equipped with electronic devices such as televisions for entertaining passengers. Some of these televisions can be mounted in the passenger's seat with controls for the device additionally mounted in the seat. However, these televisions are permanently and immovably fixed to the backs of the chairs. When a passenger adjusts the degree of reclining for the chair, the sloping degree of the television is adjusted as well. This can make it uncomfortable or inconvenient for the passenger watching the television. For small cars, televisions can be molded into the dashboard near the instrument panel, which makes it inconvenient for passengers in the backseats to watch the television.

Furthermore, electronic devices are quite expensive and therefore security systems are required in order to prevent the device from being stolen.

### SUMMARY OF THE INVENTION

Accordingly, an object of the present invention is to provide a display for a back of a chair which is easily adjusted or tilted in the back of the chair. This eliminates discomfort for users when the reclining degree or angle of the back of the chair is adjusted.

Another object of the present invention is to provide a display for a back of a chair which is convenient to remove or install in the back of the chair. In this way, the display can be taken out of the automobile when the owner leaves the automobile and prevents the display from being stolen.

To achieve the above-mentioned objects, a portable seat back display in accordance with the present invention comprises a housing, a display module and a connecting mechanism. The housing includes a frame as a receiving chamber in the back of a chair. The frame includes a backboard and side walls thereby defining a receiving space therebetween. The backboard also has a receptacle. The display module is detachably installed in the receiving space of the frame and has a complementary connector for connecting with the receptacle in the frame thereby providing the display module with a power supply and signals. The connecting mechanism is connected between the housing and the display module. The display module is rotatable in the receiving space of the housing.

A plurality of screw holes is defined in the backboard for fixing the frame in the receiving chamber to the back of the chair with screws. The frame further includes an upper wall with a support at the front thereof for preventing the display module from over-rotating.

The connecting mechanism includes a pair of guiding grooves defined in the side walls and a pair of posts formed on both sides of the display module. An arcuate recess is defined in each guiding groove, and the posts are rotatably received in the arcuate recesses.

Other objects, advantages and novel features of the present invention will be drawn from the following detailed embodiment of the present invention with attached drawings, in which:

### BRIEF DESCRIPTION OF THE DRAWINGS

FIG. 1 is an exploded view of a portable seat back display according to an embodiment of the present invention;

FIG. 2 is an assembled view of FIG. 1;

FIG. 3 is a schematic and cross-sectional view of FIG. 2; and

FIG. 4 is a side elevational view showing the display rotating relative to the back of the chair according to an embodiment of the present invention.

### DESCRIPTION OF THE PREFERRED EMBODIMENT

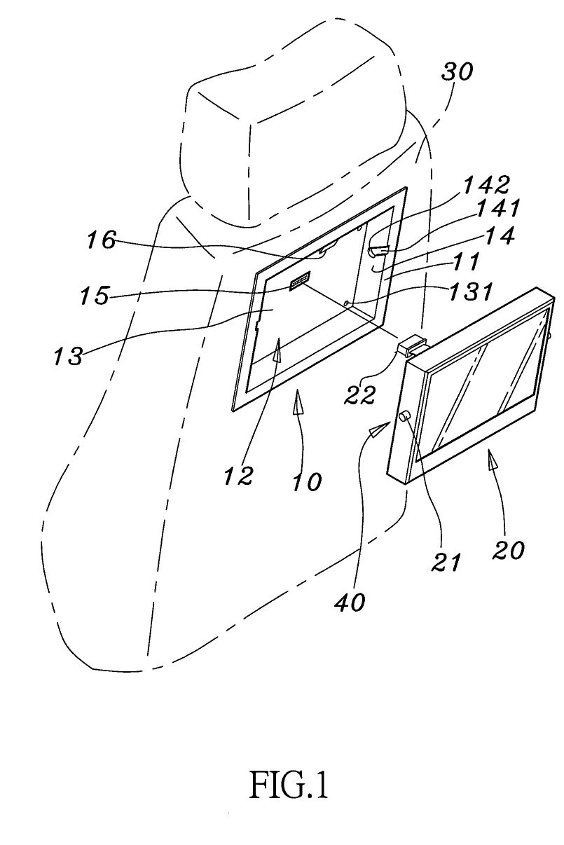

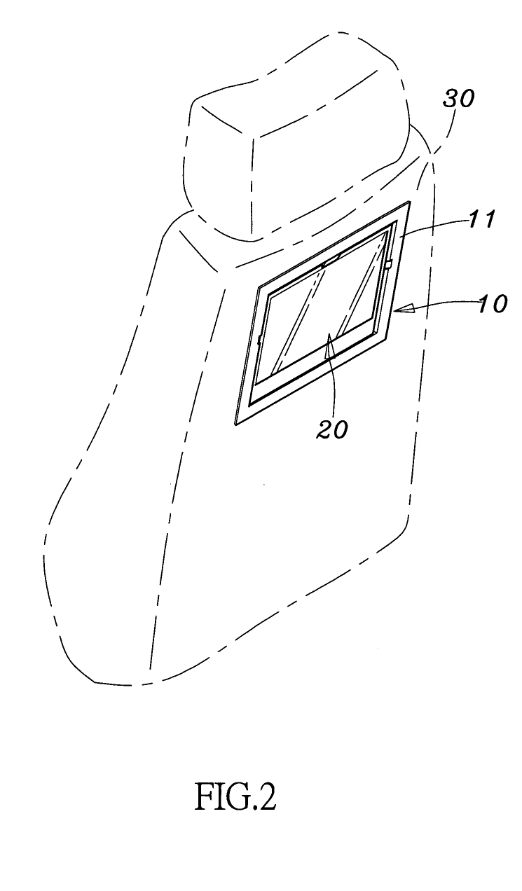

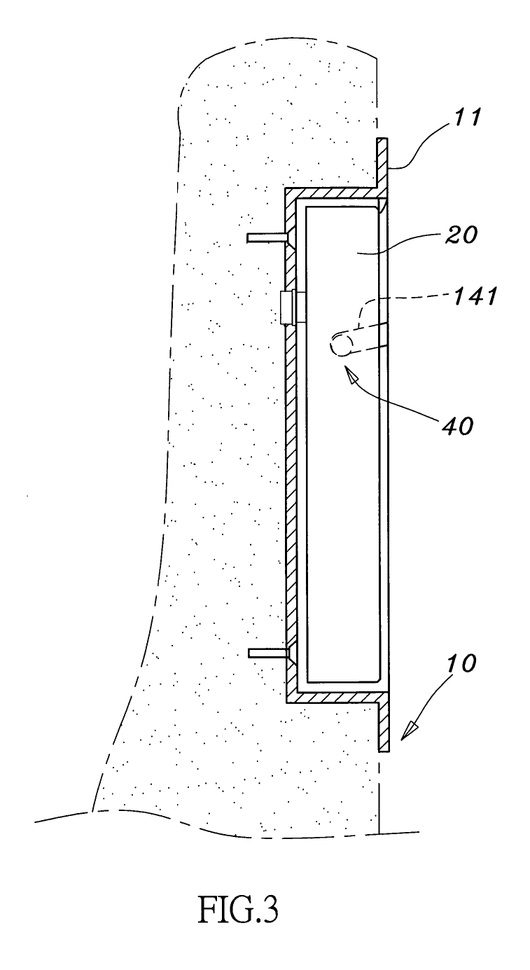

Referring to FIGS. 1-4, the portable seat back display of the present invention includes a housing 10, a display module 20 and a connecting mechanism 40. The housing 10 includes a frame 11 which includes a backboard 13 and two side walls 14 thereby defining a receiving space 12 therebetween. A plurality of screw holes 131 is defined in the backboard 13 for fixing the frame 11 in the receiving chamber 12 to the back 30 of a chair with screws. Obviously, the frame 11 may be fixed in the receiving chamber to the back 30 through adhering, riveting, soldering or other connection technologies. The backboard 13 has a receptacle 15 for connecting with a power supply line and a signal line formed in the back 30 of the chair and providing the display module 20 with power supply and display signals. The frame 11 further includes an upper wall with a support 16 at the front thereof for preventing the display module 20 from over-rotating.

The display module 20 is removably installed in the receiving space 12 of the frame 11 through the connecting mechanism 40. The connecting mechanism 40 includes a pair of guiding grooves 141 defined in the side walls 14 and a pair of posts 21 formed on both sides of the display module 20. Each guiding groove 141 is slightly sloping with an arcuate recess 142 defined in an end thereof proximate to the backboard 13. The posts 21 of the display module 20 are extendable into and slidable along the guiding grooves 141 and then are rotatably received in and engage with the arcuate recesses 142 thereby securing the display module 20 in the receiving space 12 of the frame 11. When it is required to detach the display module 20, the posts 21 are disengaged from the arcuate recesses 142 and are slid out along the guiding grooves 141 whereby the display module 20 is detached from the housing 10. Obviously, the connecting mechanism 40 may be configured in other forms. The guiding grooves 141 may be configured in both sides of the display module 20 and the posts 21 may be configured at the both side walls 14 of the frame 11.

When the display module 20 is secured in the frame 11, a complementary connector 22 of the display module 20 connects with the receptacle 15 of the frame 11 thereby providing the display module 20 with power supply and display signals.

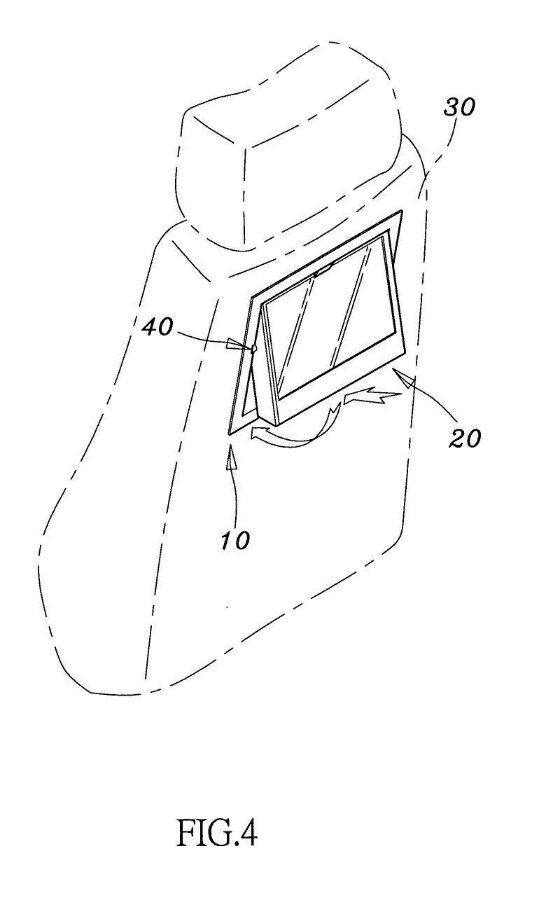

Since the display module 20 is rotatable about the posts 21 in the receiving space 12 of the housing 10, when the sloping degree or reclining angle of the back 30 of the chair is adjusted, the display module 20 is adjustable through rotation to make it comfortable to view the display module 20 (see FIG. 4). Thus, the display for the back 30 of the chair of the present invention is easily movably assembled to the back of the chair thereby preventing discomfort to the user when the sloping degree of the back of the chair is adjusted.

Since the display module 20 is conveniently detachable from the housing 10, the display module 20 can be taken away from an automobile when the owner leaves the automobile thereby preventing the display from being stolen.

It is understood that the invention may be embodied in other forms without departing from the spirit thereof. Thus, the present examples and embodiments are to be considered in all respects as illustrative and not restrictive, and the invention is not to be limited to the details given herein.

1. A seat back display, comprising:
a housing comprising a frame, a receiving chamber, a backboard, and two side walls;
a receptacle in the backboard;
a display module removably installed in the receiving space of the frame, the display module having a complementary connector for connecting with the receptacle for providing the display module with power supply and display signals; and
a connecting mechanism connecting the housing and the display module, the display module being rotatable in the receiving space of the housing.

2. The display as claimed in claim 1, further comprising a plurality of screw holes in the backboard for fixing the frame to a chair with screws.

3. The display as claimed in claim 1, wherein the frame further comprises an upper wall with a support at the front thereof for preventing the display module from over-rotating.

4. The display as claimed in claim 1, wherein the connecting mechanism comprises guiding grooves in the side walls of the frame.

5. The display as claimed in claim 1, wherein the connecting mechanism comprises a post formed on both sides of the display module.

6. The display as claimed in claim 4, wherein each guiding groove is slightly sloping towards the backboard.

7. The display as claimed in claim 4, wherein an arcuate recess is defined in an end of each guiding groove proximate to the backboard.

8. The display as claimed in claim 1, wherein the connecting mechanism comprises:
guiding grooves in the side walls;
a post formed on both sides of the display module; and
an arcuate recess in each guiding groove;
whereby the posts are rotatably received in the arcuate recesses.

9. A seat back display, comprising:
a display module;
a connecter attached to the display module;
a post on two sides of the display module;
a housing for receiving the display module, the housing comprising;
a receptacle for connecting with the connecter and for providing power supply and display signals to the display module;
a guide groove in sides of the housing for receiving the posts on the display module and removably attaching the display module to the housing while allowing the display module to be rotated within the housing; and
a support in the housing for preventing over-rotation of the display module.

10. The display as claimed in claim 9, further comprising a plurality of screw holes in the housing for fixing the housing to a chair with screws.

11. The display as claimed in claim 9, wherein each guiding groove is slightly sloping downwards from front to back.

12. The display as claimed in claim 9, wherein an arcuate recess is defined in an end of each guiding groove.
